(19) United States
(12) Patent Application Publication
(10) Pub. No.: US 2023/0192149 A1
(43) Pub. Date: Jun. 22, 2023

(54) DRIVING CONDITION DETERMINATION METHOD, AUTONOMOUS DRIVING SYSTEM

(71) Applicant: TOYOTA JIDOSHA KABUSHIKI KAISHA, Toyota-shi Aichi-ken (JP)

(72) Inventor: Satoru Uchiyama, Susono-shi Shizuoka-ken (JP)

(73) Assignee: TOYOTA JIDOSHA KABUSHIKI KAISHA, Toyota-shi Aichi-ken (JP)

(21) Appl. No.: 17/977,058

(22) Filed: Oct. 31, 2022

(30) Foreign Application Priority Data
Dec. 20, 2021 (JP) 2021-205765

(51) Int. Cl. B60W 60/00; B60W 30/18; B60W 50/14

(52) U.S. Cl. CPC B60W 60/0053; B60W 30/18163; B60W 50/14; B60W 2552/10; B60W 2520/10; B60W 2540/22; B60W 2554/4041; B60W 2050/146

(57) ABSTRACT

The driving condition determination method according to the present disclosure includes: detecting a lane-free merging point on a traveling route of a vehicle by autonomous driving; executing a determination process for determining whether or not there is a high possibility of giving anxiety to a driver when a vehicle passes through a lane-free merging point by autonomous driving based on a passing speed when passing through a merging portion or a length of a merging section in response to detecting a lane-free merging point; and continuing autonomous driving when it is not determined that there is a high possibility of giving anxiety, and implementing switching to manual driving when it is determined that there is a high possibility of giving anxiety.

### CROSS-REFERENCE TO RELATED APPLICATION

This application claims priority to Japanese Patent Application No. 2021-205765 filed on Dec. 20, 2021, incorporated herein by reference in its entirety.

### BACKGROUND

### 1. Technical Field

The present disclosure relates to a technique that determines a continuation of autonomous driving of a vehicle and switching to manual driving in accordance with a traveling environment.

### 2. Description of Related Art

In an autonomous driving system that performs autonomous driving of a vehicle, there is a case in which switching to manual driving in accordance with a traveling environment is performed for the purpose of assuring safety and lowering anxiety of the driver, and the like. Here, regarding appropriately performing the determination of continuing autonomous driving and switching to manual driving in accordance with the traveling environment, various conventional techniques have been proposed.

For example, Japanese Patent No. 6856134 (JP 6856134 B) discloses a technique in which a point, on a route that an own vehicle is scheduled to travel, at which a traveling lane of the own vehicle is connected to another lane, and at which a traffic situation of another lane cannot be determined is extracted as a high difficulty point. In the technique, switching of a traveling state of the own vehicle from autonomous driving to manual driving is shown at a point before the extracted high difficulty point by a predetermined distance. Japanese Unexamined Patent Application Publication No. 2021-059327 (JP 2021-059327 A) and Japanese Unexamined Patent Application Publication No. 2019-109666 (JP 2019-109666 A) are exemplified as conventional techniques.

### SUMMARY

A lane-free merging point is an example of a traveling environment in which determination of continuation of autonomous driving and switching to manual driving is required. In the case of passing through a lane-free merging point by autonomous driving, there is a possibility of causing a driver to still feel anxious even when a hands-on request is made at some points or under some circumstances.

However, when the prior art disclosed in JP 6856134 B is applied with the lane-free merging point serving as the high difficulty point, switching to manual driving is performed even in the lane-free merging point in which there is no possibility of causing the driver to feel anxious, and an availability of autonomous driving is reduced.

One object of the present disclosure is to provide a technique capable of determining continuation of autonomous driving and switching to manual driving without reducing the availability of autonomous driving upon passage of a lane-free merging point.

The first disclosure relates to a driving condition determination method that determines a continuation of autonomous driving of a vehicle and switching to manual driving in accordance with a traveling environment. The driving condition determination method according to a first disclosure includes: detecting a lane-free merging point on a traveling route of the vehicle by the autonomous driving; executing a determination process that determines whether there is a high possibility of causing a driver to feel anxious when the vehicle passes through the lane-free merging point by the autonomous driving based on a passing speed when the vehicle passes through a merging portion or a length of a merging section, in response to a detection of the lane-free merging point; and continuing the autonomous driving when the driving condition determination method does not determine that there is a high possibility of causing the driver to feel anxious, and performing switching to the manual driving when the driving condition determination method determines that there is a high possibility of causing the driver to feel anxious.

The second disclosure relates to the driving condition determination method further including the following characteristics, with respect to the driving condition determination method according to the first disclosure. The determination process may include determining that a possibility of causing the driver to feel anxious is high when an expected passage time acquired by dividing the length of the merging section by the passing speed is equal to or less than a predetermined first threshold value.

The third disclosure relates to the driving condition determination method further including the following characteristics, with respect to the driving condition determination method according to the second disclosure. The determination process may include changing the first threshold value in accordance with an absolute value of a difference between the passing speed and an expected speed when another vehicle traveling in another lane at the lane-free merging point passes through the merging portion.

The fourth disclosure relates to the driving condition determination method further including the following characteristics, with respect to the driving condition determination method according to the first or second disclosure. The determination process may include determining that a possibility of causing the driver to feel anxious is high when an absolute value of a difference between the passing speed and an expected speed when another vehicle traveling in another lane at the lane-free merging point passes through the merging portion is equal to or more than a predetermined second threshold value.

The fifth disclosure relates to the driving condition determination method further including the following characteristics, with respect to the driving condition determination method according to the third or fourth disclosure. The driving condition determination method may further include calculating a target speed of the vehicle when the vehicle passes the merging portion may be calculated as the expected speed when assuming that the vehicle travels in the other lane based on map information.

The sixth disclosure relates to the driving condition determination method further including the following characteristics, with respect to the driving condition determination method according to any one of the first to fifth disclosures. The driving condition determination method according to the sixth disclosure may further include calculating a merging start point at which the vehicle passes through a hard nose or a soft nose of the lane-free merging point and calculating a merging end point that is after the vehicle passes the merging start point based on map information, and calculating a length between the merging start point and the merging end point as the length of the merging section.

The seventh disclosure relates to the driving condition determination method further including the following characteristics, with respect to the driving condition determination method according to any one of the first to sixth disclosures. Performing switching to the manual driving may include displaying a reason for switching to the manual driving on a display device.

The eighth disclosure relates to the driving condition determination method further including the following characteristics, with respect to the driving condition determination method according to any one of the first to seventh disclosures. Performing switching to the manual driving may include: sending a notification to the driver that switching to the manual driving is to be performed; receiving a response of the driver to the notification; and switching to the manual driving when reception of the response is not performed for a predetermined time from a time point of the notification.

The ninth disclosure relates to an autonomous driving system that performs autonomous driving of a vehicle. The autonomous driving system according to ninth disclosure includes one or more processors, in which the one or more processors may be configured to execute: a process of detecting a lane-free merging point on a traveling route of the vehicle by the autonomous driving; a determination process that determines whether there is a high possibility of causing a driver to be anxious when the vehicle passes through the lane-free merging point by the autonomous driving based on a passing speed when the vehicle passes through a merging portion or a length of a merging section, in response to a detection of the lane-free merging point; and a driving state determination process that continues the autonomous driving when the one or more processors does not determine that there is a high possibility of causing the driver to feel anxious, and that performs switching to manual driving when the one of more processors determines that there is a high possibility of causing the driver to feel anxious.

The tenth disclosure relates to the autonomous driving system further including the following characteristics, with respect to the autonomous driving system according to the ninth disclosure. The determination process may include determining that a possibility of causing the driver to feel anxious is high when an expected passage time acquired by dividing the length of the merging section by the passing speed is equal to or less than a predetermined first threshold value.

The eleventh disclosure relates to the autonomous driving system further including the following characteristics, with respect to the autonomous driving system according to the tenth disclosure. The determination process may include changing the first threshold value in accordance with an absolute value of a difference between the passing speed and an expected speed when another vehicle traveling in another lane at the lane-free merging point passes through the merging portion.

The twelfth disclosure relates to the autonomous driving system further including the following characteristics, with respect to the autonomous driving system according to the ninth or tenth disclosure. The determination process may include determining that a possibility of causing the driver to feel anxious is high when an absolute value of a difference between the passing speed and an expected speed when another vehicle traveling in another lane at the lane-free merging point passes through the merging portion is equal to or more than a predetermined second threshold value.

The thirteenth disclosure relates to the autonomous driving system further including the following characteristics, with respect to the autonomous driving system according to the eleventh or twelfth disclosure. The one or more processors may be configured to further execute a process of calculating, as the expected speed, a target speed of the vehicle when the vehicle passes through the merging portion when the vehicle is assumed to travel the other lane based on map information.

The fourteenth disclosure relates to the autonomous driving system further including the following characteristics, with respect to the autonomous driving system according to any one of the ninth to thirteenth disclosures. The one or more processors may be configured to further execute a process of calculating a merging start point at which the vehicle passes through a hard nose or a soft nose of the lane-free merging point and calculating a merging end point at which a lane width becomes equal to or less than a predetermined value after the vehicle passes through the merging start point, and a process of calculating a length between the merging start point and the merging end point as the length of the merging section.

The fifteenth disclosure relates to the autonomous driving system further including the following characteristics, with respect to the autonomous driving system according to any one of the ninth to fourteenth disclosures. The autonomous driving system according to the fifteenth disclosure further includes a display device.

The driving state determination process may include displaying on the display device, a reason for switching to the manual driving when performing switching to the manual driving.

The sixteenth disclosure relates to the autonomous driving system further including the following characteristics, with respect to the autonomous driving system according to any one of the ninth to fifteenth disclosures. When the driving state determination process determines that a possibility of causing the driver to feel anxious is high, the driving state determination process may include: a process of sending a notification that switching to the manual driving is to be performed; a process of receiving a response of the driver to the notification; and a process of switching to the manual driving when reception of the response is not performed for a predetermined time from a time point of the notification.

According to the present disclosure, the determination process is executed when the lane-free merging point on the traveling route is detected. Then, autonomous driving is continued when it is determined that there is a high possibility of causing the driver to feel anxious, and switching to manual driving is performed when it is determined that there is a high possibility of causing the driver to feel anxious. This makes it possible to determine the continuation of autonomous driving and switching to manual driving without decreasing the availability of autonomous driving when passing through the lane-free merging point.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram for explaining the lane-free merging point;

FIG. 2A is a conceptual diagram for describing the merging section;

FIG. 2B is a conceptual diagram for describing a length of the merging section;

FIG. 3 is a block diagram showing a configuration of the autonomous driving system according to the present embodiment;

FIG. 4 is a flowchart showing a process according to the determination of the switching to continuous and manual driving of the autonomous driving executed in the autonomous driving system according to the present embodiment;

FIG. 5 is a flowchart showing a first example of the determination process;

FIG. 6 is a flowchart illustrating a second example of the determination process;

FIG. 7 is a flowchart showing a third example of the determination process;

### DETAILED DESCRIPTION OF EMBODIMENTS

Hereinafter, an embodiment of the present disclosure will be described with reference to the drawings. However, when the number, quantity, amount, range, etc. of each element are referred to in the embodiments shown below, the idea of the present disclosure is not limited to the numbers mentioned herein except when explicitly stated or when clearly specified by the number in principle. In addition, the configurations and the like described in the embodiments shown below are not necessary to the idea of the present disclosure, except when explicitly stated or when clearly specified in principle. In each figure, the same or corresponding parts are designated by the same reference signs, and duplicated description thereof will be appropriately simplified or omitted.

### 1. Outline

In the autonomous driving system for performing autonomous driving of the vehicle, typically, information the sensor provided in the vehicle detects (e.g., information of the ambient environment and the traveling state) and information to be acquired via a communication device (e.g., map information and GPS position information) recognizes the traveling environment from, the traveling route corresponding to the traveling environment is generated. Then, as the vehicle travels along the traveling route, acceleration, steering, autonomous driving is realized by running control according to the braking is performed.

On the other hand, in the autonomous driving system, switching to manual driving is sometimes carried out according to the running environment for the purpose of assurance of safety and reduction of anxiety to the driver, etc. In this case, it is necessary to perform the determination of the switching to the continuation and manual driving of the autonomous driving according to the traveling environment. Incidentally, switching to the manual driving can also be referred to as “system off”. The continuation of the autonomous driving can also be referred to as “continuation of the system on”.

A lane-free merging point is an example of a traveling environment in which determination of continuation of autonomous driving and switching to manual driving is required. autonomous driving system according to the present embodiment, when the vehicle passes through the lane-free merging point, has a feature in the determination of the switching to continuous and manual driving of the autonomous driving.

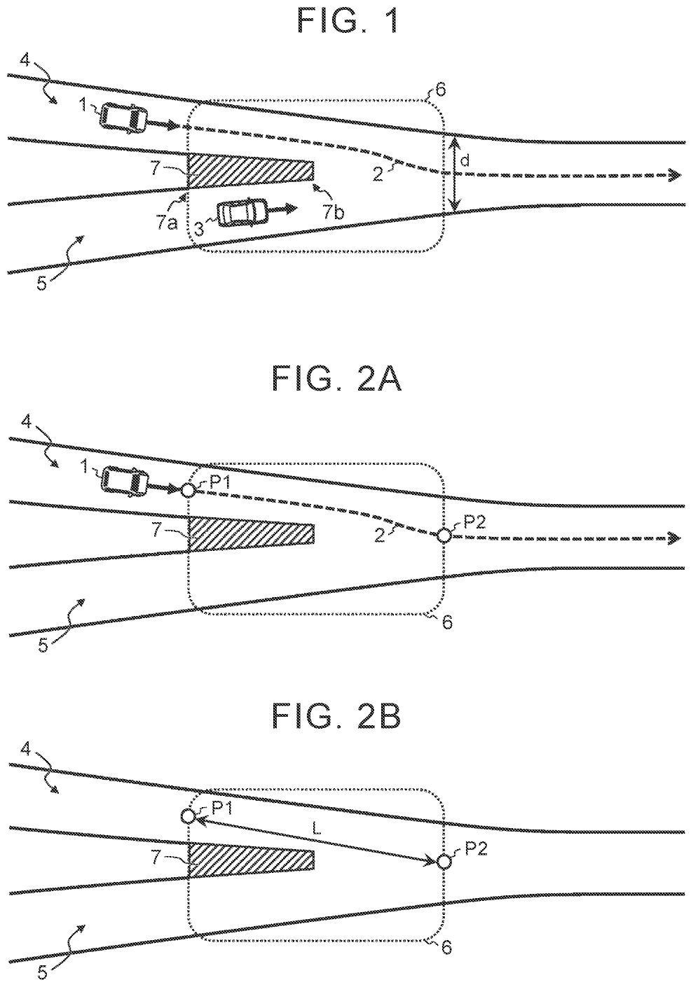

FIG. 1 is a conceptual diagram for explaining a lane-free merging point. FIG. 1 shows a state in which a vehicle 1 to which an autonomous driving system is applied (hereinafter also referred to as “own vehicle 1”) attempts to pass a lane-free merging point along a traveling route 2 by autonomous driving. Further, in FIG. 1, the other vehicle 3 traveling in the other lane 5 serving as the mating side of the merger with respect to the own lane 4 in which the own vehicle 1 travels is shown. Incidentally, in FIG. 1, the arrow of the solid line shows the speed direction of each of the own vehicle 1 and the other vehicle 3.

The lane-free merging point is a merging point without lanes for merging of acceleration lanes, etc. in the merging portion 6, as shown in FIG. 1. Such lane-free merging points are often found in the vicinity of highway interchanges and in urban areas. Here, the merging portion 6 is a range in which joining is possible. In the example shown in FIG. 1, the merging portion 6 is a range from the hard nose 7a is the start end of the flow guide band 7 (zebra zone) to the lane width d is equal to or less than a predetermined value. However, the merging portion 6 may be a range from the soft nose 7b is a termination of the flow guide band 7 until the lane width d is equal to or less than a predetermined value.

In the conventional autonomous driving system, it is possible to pass through the lane-free merging point by continuing the autonomous driving. However, in certain cases such as when the other vehicle 3 from the other lane 5 approaches at the time of merging, switching to the manual driving is performed to require the driving operation to the driver. This is because, depending on the autonomous driving, it is difficult to merge autonomously taking an appropriate distance by recognizing the other vehicle 3 approaching from the other lane 5, and the like.

Therefore, in the conventional autonomous driving system, when passing through the lane-free merging point by autonomous driving, from before a predetermined distance of the lane-free merging point until passing through the merging portion 6, it is considered to make a hands-on request to the driver. Thus, the driver can recognize in advance that the switching to the manual driving may be performed, it is possible to perform the driving operation with a margin when the switching to the manual driving is performed. In the extension, the possibility of giving anxiety to the driver when passing through the lane-free merging point can be reduced by the autonomous driving.

However, the inventor of the present disclosure has found that, in some locations or under some circumstances, such as when the length of the merging section is short or when the vehicle speed of the own vehicle 1 is high, even if a hands-on request is made, the driver still feels anxious about passing through the lane-free merging point by autonomous driving. In such a case, it is desirable to switch to manual driving before reaching the merging portion 6, e.g., at the time of making a hands-on request.

On the other hand, if switching to manual driving is performed without making a hands-on request for all lane-free merging points (e.g., extracting a lane-free merging point as a high difficulty point by applying the prior art disclosed in Japanese Patent No. 6856134), switching to manual driving will be performed even in a case where a hands-on request is sufficient. Consequently, the availability of autonomous driving is deteriorated.

Therefore, in the autonomous driving system according to the present embodiment, a process of determining whether or not there is a high possibility of causing anxiety to the driver when a lane-free merging point is detected on the traveling route 2 and the vehicle passes through the lane-free merging point by autonomous driving (hereinafter, also referred to as “determination process”) is executed. When it is determined by the determination process that there is a high possibility of causing anxiety to the driver, the autonomous driving is continued, and when it is determined that there is a high possibility of causing anxiety to the driver, the switching to the manual driving is performed. The determination as to whether or not there is a high possibility of causing anxiety to the driver can be made based on the expected speed when the vehicle 1 passes through the merging portion 6 (hereinafter, also referred to as “passing speed”) or the length of the merging section. When it is determined that the autonomous driving is to be continued, a hands-on request may be made.

Incidentally, the merging section is a section between the own vehicle 1 passes through the merging portion 6. The merging section will be described with reference to FIGS. 2A and 2B. In the example shown in FIG. 2S, as the start point and the end point while the vehicle 1 passes through the merging portion 6, the merging start point P1 and the merging end point P2 is shown. Merging section is the section between the merging start point P1 and the merging end point P2. Thus, as shown in FIG. 2B, the length of the merging section is the length L between the merging start point P1 and the merging end point P2. However, the length of the merging section may be a length along the traveling route 2 from the merging start point P1 to the merging end point P2.

Several examples are given as the determination process executed in the autonomous driving system according to the present embodiment. Hereinafter, some examples of the determination process executed in the autonomous driving system according to the present embodiment will be outlined.

In the first example, an estimated time at which the vehicle 1 passes through the merging portion 6 (hereinafter, also referred to simply as “estimated passing time”) is used as an index. The expected transit time can be obtained by dividing the length of the merging section by the transit speed. That is, when the passing speed is v and the length of the merging section is L, the expected passing time is expressed by the following equation (1).

$$Equation 1$$

$$\frac{L}{v} \qquad ( 1 )$$

Passage expected time can be regarded as the time margin for the driver to perform the driving operation in the merging portion 6 when the switching to the manual driving is performed. The smaller the time margin, the greater the amount of operation of the driving operation required by the driver. In other words, it can be said that the shorter the expected passage time, the higher the possibility of causing anxiety to the driver. Therefore, in the first example, it is determined that there is a high possibility of causing anxiety to the driver when the expected passage time becomes equal to or less than a predetermined threshold value (first threshold value). In the first example, the larger the passing speed, and the shorter the length of the merging section, so that the possibility of giving anxiety to the driver is increased.

In the second example, the absolute value of the difference between the expected speed (hereinafter also referred to as “other vehicle speed”) when the other vehicle 3 traveling in the other lane 5 passes through the merging portion 6 and the passing speed of the own vehicle 1 is used as an index. This is expressed by the following equation (2) when the other vehicle speed is v′ and the passing speed is v.

|v−′| Equation 2

When performing merging, it will be performed driving operation to match the speed of the own vehicle 1 to the speed of the other vehicle 3. Therefore, the larger the absolute value of the difference between the other vehicle speed and the passing speed, the greater the manipulated variable of the driving operation required for the driver in the merging portion 6 when the switching to the manual driving is performed. That is, it can be said that the greater the absolute value of the difference between the other vehicle speed and the passing speed, the higher the possibility of causing anxiety to the driver. Therefore, in the second example, the absolute value of the difference between the other vehicle speed and the passing speed is determined to be likely to give anxiety to the driver when the predetermined threshold value (second threshold value) or more.

A third example is a combination of a first example and a second example. That is, when the expected passage time becomes equal to or less than the first threshold value, or when the absolute value of the difference between the other vehicle speed and the passing speed becomes equal to or more than the second threshold value, it is determined that there is a high possibility of causing anxiety to the driver.

In addition, as a modification of the first example, it is determined that there is a high possibility of giving anxiety to the driver when the passage predicted time is equal to or less than the first threshold value, it is conceivable to change the first threshold value according to the absolute value of the difference between the other vehicle speed and the passing speed.

### 2. Autonomous Driving System

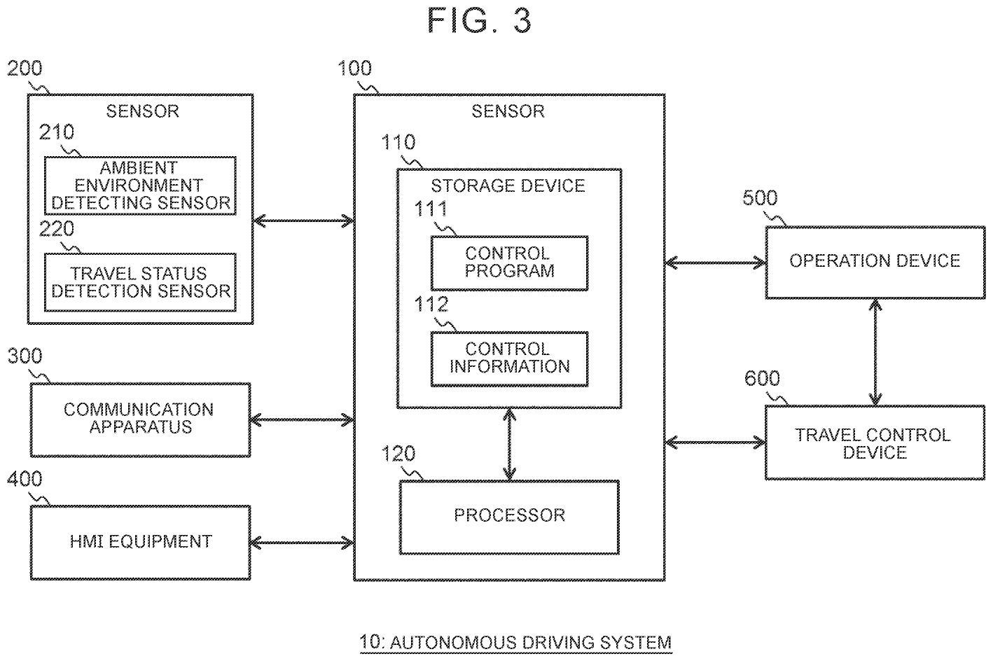

Hereinafter, a schematic configuration of the autonomous driving system 10 according to the present embodiment will be described with reference to FIG. 3. The autonomous driving system 10 includes a control device 100, a sensor 200, a communication device 300, an HMI device 400, a driving operation device 500, and a travel control device 600. The control device 100 is configured to be capable of transmitting information to each other with the sensor 200, the communication device 300, the HMI device 400, the driving operation device 500, and the travel control device 600. Typically, it is electrically connected by a wiring harness. As other configurations, connection by wireless communication, connection by an optical communication line, and the like are exemplified. Further, the travel control device 600 is configured to be able to transmit information to each other with the driving operation device 500.

Sensor 200 detects information relating to the traveling environment of the vehicle 1, and outputs the detection information. Detection information output by the sensor 200 is transmitted to the control device 100. Sensor 200 includes an ambient environment detecting sensor 210 for detecting information of the surrounding environment of the vehicle 1 (the preceding vehicle, white line, obstacles, etc.), the traveling state of the vehicle 1 (vehicle speed, acceleration, yaw rate, etc.) and a traveling state detecting sensor 220 for detecting information.

Examples of the ambient environment detecting sensor 210 include cameras, millimeter-wave radars, and LiDAR. As the traveling state detecting sensor 220, a wheel speed sensor for detecting the vehicle speed of the vehicle 1, a G sensor for detecting the acceleration of the vehicle 1, a gyro sensor for detecting the angular velocity of the vehicle 1, and the like are exemplified.

The detection information output by the sensors 200 may include, in addition to information that is directly detected by the sensors 200, information acquired by arithmetic processing based on the directly detected information. For example, from the image information camera acquires, information acquired by image recognition (such as the distance and the classification of obstacles to the preceding vehicle) may be output as the detection information. In this case, the arithmetic processing may be executed in each sensor 200, or the sensor 200 may include a device that executes the arithmetic processing.

The communication device 300 performs transmission and reception of various information by communicating with a device outside the vehicle 1. Examples of the communication device 300 include a wireless communication device that communicates with an infrastructure or a surrounding vehicle, a GPS receiver, and a device that connects to the Internet and communicates with a server on the Internet. The communication information received by the communication device 300 is transmitted to the control device 100. Examples of the communication information transmitted to the control device 100 include map information, road traffic information, position information by GPS, and the like. Here, the map information may be high-precision map information including information such as a road shape.

The HMI device 400 is a device that provides an HMI function. Examples of the HMI device 400 include a display (display device), a speaker, a touch panel, a switch, an indicator, and the like. The HMI device 400 realizes operations such as settings related to autonomous driving by the driver and notifications related to autonomous driving to the driver. For example, setting of a destination, turning on/off of each function, display of a surrounding map, a request to start autonomous driving, and the like are realized.

Based on the acquired information, the control device 100 executes processing relating to autonomous driving and outputs a control signal. The control device 100 is typically realized by one or a plurality of Electronic Control Unit (ECU) included in the vehicle 1. Alternatively, it may be implemented by a server configured on a communication network, typically on the Internet. In this case, the control device 100 acquires information by communication via a communication network and transmits a control signal.

The control device 100 includes one or a plurality of storage devices 110 and one or a plurality of processors 120. The one or more storage devices 110 store a control program 111 executable by the one or more processors 120 and control information 112 necessary for processing executed by the one or more processors 120. Examples of the storage device 110 include a volatile memory, a nonvolatile memory, an HDD, and an SSD. The information acquired by the control device 100 is stored in the storage device 110 as the control information 112. As the control information 112, for example, detection information of the sensor 200, map information, road traffic information, parameter information relating to the control program 111 is exemplified.

The control program 111 includes a program related to autonomous driving. For example, programs related to recognition processing of the traveling environment, self-position estimation processing, generation processing of the traveling route 2, traveling control processing along the traveling route 2, and the like are included. Further, the control program 111 includes a program relating to switching to the manual driving according to the traveling environment.

The one or more processors 120 read the control program 111 and the control information 112 from the one or more storage devices 110 and execute a process according to the control program 111 based on the control information 112. Thus, the processing according to the switching to the manual driving according to the processing and the running environment according to the autonomous driving is executed, the control signal is generated.

Control signal according to the traveling of the vehicle 1 output by the control device 100 is transmitted to the travel control device 600. For example, acceleration, steering, a control signal for notifying the system state of the control signal and the autonomous driving to provide a control amount according to the braking (on-off of the system) is transmitted to the travel control device 600. The control signal output by the control device 100 may include a control signal transmitted to the HMI device 400. For example, a control signal for notifying the system status of the autonomous driving may also be transmitted to the HMI device 400. In this case, the HMI device 400 operates in accordance with the control signal, for example, performs sound or display, thereby realizing notification of the system state to the driver.

The driving operation device 500 receives a driving operation by a driver and outputs operation information. As the driving operation device 500, a gas pedal, a brake pedal, a steering wheel, and the like are exemplified. As the operation information, the accelerator operation amount, the amount of depression of the brake pedal, the steering angle, and the like are exemplified. The operation information output by the driving operation device 500 is transmitted to the control device 100 and the travel control device 600.

Travel control device 600 is a device for executing a process according to the traveling control of the vehicle 1. The travel control device 600, by the travel control is performed according to the control signal acquired from the control device 100, the autonomous driving of the vehicle 1 is realized. Further, by the travel control is performed according to the operation information acquired from the driving operation device 500, the manual driving of the vehicle 1 by the driver is realized.

Here, the travel control device 600 is configured to switch, based on a control signal acquired from the control device 100, whether to perform the traveling control according to a control signal acquired from the control device 100 or to perform the traveling control according to the operation information acquired from the driving operation device 500. For example, the travel control device 600 is configured to grasp the system state of the autonomous driving by a control signal acquired from the control device 100, and to switch whether to perform any of the traveling control according to the system state. Thus, switching to manual driving by the control device 100 is realized.

Travel control device 600, for example, a group of actuators provided in the vehicle 1, and an ECU for controlling the operation of a group of actuators. An actuator for driving a power device (an internal combustion engine, an electric motor, or the like), an actuator for driving a brake mechanism, an actuator for driving a steering mechanism, or the like are exemplified as a group of actuators provided in the vehicle 1.

### 3. Processing

autonomous driving system 10 according to the present embodiment, when the vehicle 1 passes through the lane-free merging point, has a feature in the determination of the switching to continuous and manual driving of the autonomous driving. Hereinafter, in the autonomous driving system 10 according to the present embodiment, characteristic processing relating to determination of continuation of the autonomous driving and switching to the manual driving, which is executed by one or a plurality of processors 120, will be described.

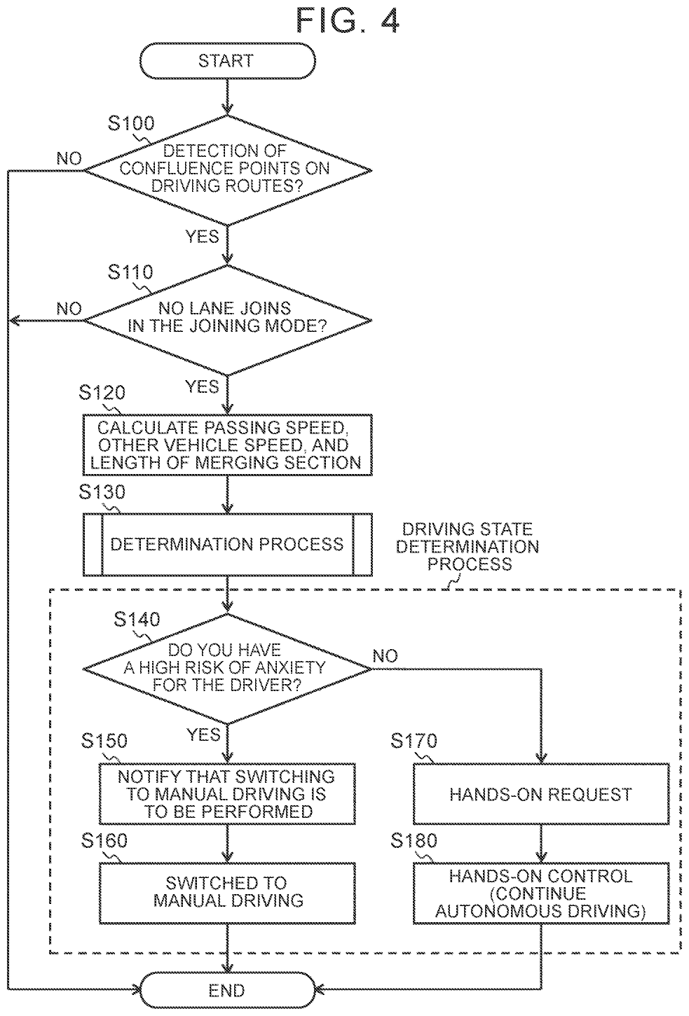

FIG. 4 is a flowchart showing characteristic processing relating to determination of continuation of autonomous driving and switching to manual driving, which is executed by one or more processors 120. Processing of the flowchart shown in FIG. 4 is started by the execution of the autonomous driving, during the continuation of the autonomous driving is repeatedly executed for each predetermined control cycle.

In step S100, the one or more processors 120 determine whether or not a merging point is detected on the traveling route 2. This can be determined, for example, from the map information on the traveling route 2. Alternatively, the determination may be made based on the detection information output from the sensor 200. For example, it is determined whether or not a merging point is detected on the traveling route 2 by image recognition of image information detected by cameras, point cloud recognition of point cloud information detected by LiDAR, or combinations thereof.

When a merging point is detected on the traveling route 2 (step S100; Yes), the process proceeds to step S110. When the joining point is not detected on the traveling route 2 (step S100; No), the process ends this time.

In step S110, the one or more processors 120 determines whether or not the merging form of the merging point detected in step S100 is the lane-free merging. That is, it is determined whether or not the lane-free merging point is detected on the traveling route 2. This can be determined from the map information on the traveling route 2 in the same manner as the map information on S100 of steps. Alternatively, it may be determined from the detection information output from the sensor 200. Here, the step S100 and the step S110 may be executed simultaneously.

If the merging mode is lane-free merging (step S110; YES), the process proceeds to step S120. If the merging mode is not lane-free merging (step S110; No), the process ends this time.

In step S120, the one or more processors 120 calculate the passing speed, the other vehicle speed, and the length of the merging section. However, values that are not required in the determination process (step S130) may not be calculated. For example, in the case where the determination process is executed using the estimated passage time as an index, the speed of the other vehicle may not be calculated.

The passing speed is calculated, for example, as follows. The autonomous driving system 10 generally has a function of appropriately controlling the vehicle speed based on the map information (curve shape or the like) of the own lane 4 while setting the vehicle speed set by the driver to the upper limit (hereinafter, also referred to as “vehicle speed control function”). Then, by the vehicle speed control function, it is possible to calculate the target speed (upper limit vehicle speed) at the merging start point P1 in front of the merging section. Therefore, one or a plurality of processors 120 calculate the target speed at the merging start point P1 as the passing speed. Alternatively, the vehicle speed set by the driver may be calculated as the passing speed.

The calculation of the other vehicle speed is performed, for example, as follows. By giving the map information of the other lane 5 in the above-described vehicle speed control function, it is possible to calculate the target speed of the vehicle 1 when passing through the merging portion 6 when it is assumed that the vehicle 1 travels in the other lane 5. Thus, one or more processors 120 calculate the target speed of the vehicle 1 when passing through the merging portion 6 when it is assumed that the vehicle 1 travels in the other lane 5 as the other vehicle speed. By thus calculating the other vehicle speed, without performing communication with the detection and the other vehicle 3 of the other vehicle 3 by the sensor 200, it is possible to calculate the other vehicle speed.

The calculation of the length of the merging section is performed, for example, as follows. On the basis of the map information, the one or more processors 120 calculate a point at which the vehicle 1 passes through the hard nose 7a or the soft nose 7b in the traveling route 2 as a merging start point P1. The point where the lane width d becomes a predetermined value or less after passing through the merging start point P1 is calculated as the merging end point P2. Then, the length between the merging start point P1 and the merging end point P2 is calculated as the length of the merging section. By thus calculating the length of the merging section, it is possible to appropriately determine the merging portion 6 from the map information, to calculate the length of the merging section.

After step S120, the process proceeds to step S130.

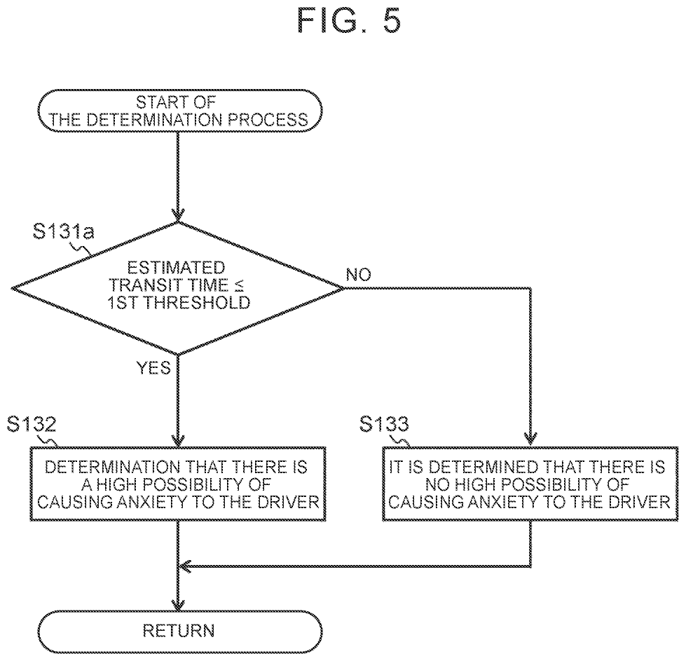

In step S130, one or more processors 120 perform a determination process. Referring now to FIGS. 5-7, processing performed by one or more processors 120 for some examples of determination process will be described.

FIG. 5 is a flowchart showing processing executed by one or a plurality of processors 120 for the first example of the determination process. The one or more processors 120 may determine S131a whether the expected transit times are less than or equal to the first thresholds. Then, when the predicted passage time becomes equal to or less than the first threshold value (step S131a; Yes), it is determined that there is a high possibility of causing anxiety to the driver (step S132), and when the predicted passage time is larger than the first threshold value (step S131a; No), it is determined that there is no high possibility of causing anxiety to the driver (step S133).

In the first example of the determination process, the one or more processors 120 may execute a process of changing the first threshold in accordance with the absolute value of the difference between the other vehicle speed and the passing speed. For example, the larger the absolute value of the difference between the other vehicle speed and the passing speed, the larger the first threshold value. Thus, when the absolute value of the difference between the other vehicle speed and the passing speed is large, it is likely to cause anxiety to the driver is increased, it can be easily determined that it is likely to cause anxiety to the driver.

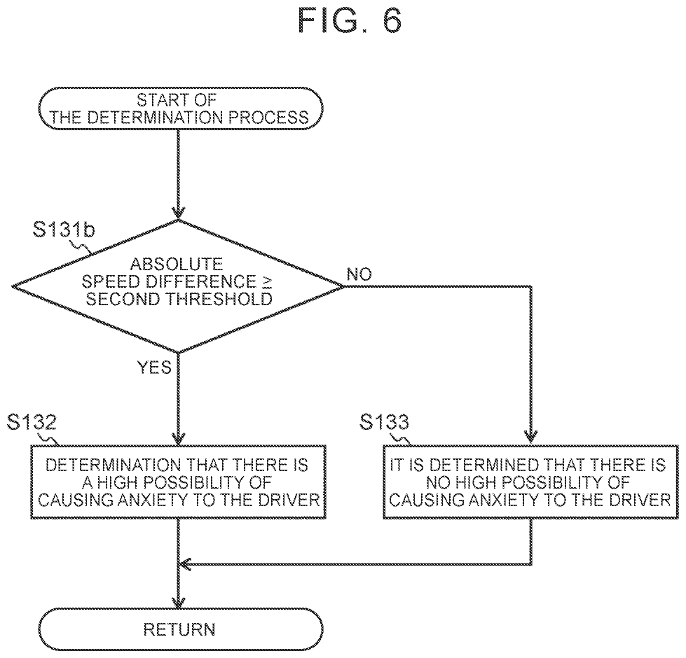

FIG. 6 is a flowchart showing processing executed by one or a plurality of processors 120 for the second example of the determination process. The one or more processors 120 determine whether or not the absolute value of the difference (speed difference) between the other vehicle speed and the passing speed is equal to or greater than the second threshold value (step S131b). Then, when the absolute value of the difference between the other vehicle speed and the passing speed is equal to or greater than the second threshold value (step S131b; Yes), it is determined that the possibility of causing anxiety to the driver is high (step S132), and when the absolute value of the difference between the other vehicle speed and the passing speed is less than the second threshold value (step S131b; No), it is determined that the possibility of causing anxiety to the driver is not high (step S133).

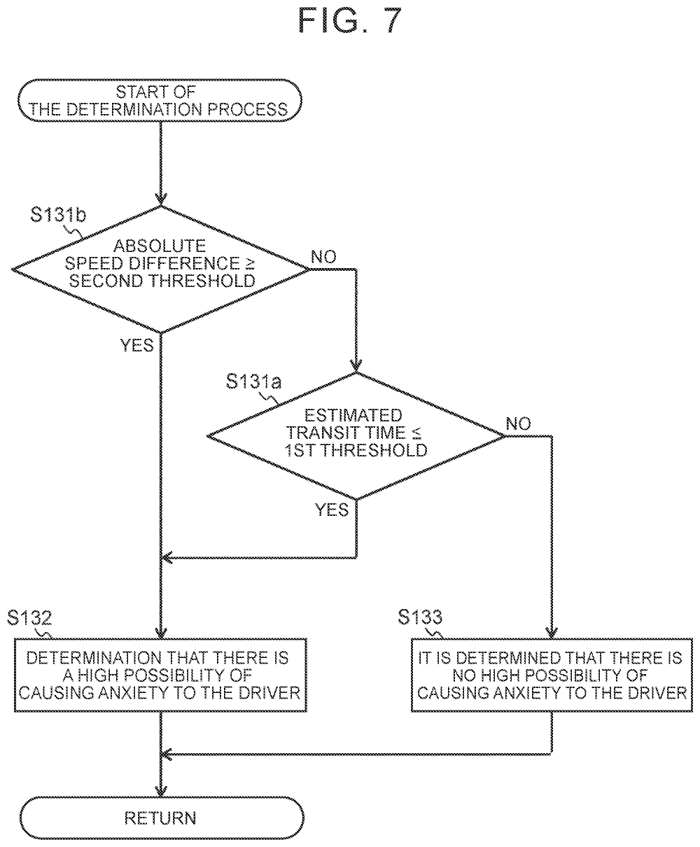

FIG. 7 is a flowchart showing processing executed by one or a plurality of processors 120 for the third example of the determination process. When the absolute value of the difference between the other vehicle speed and the passing speed is equal to or greater than the second threshold value (step S131b; Yes), or when the expected passing time is equal to or less than the first threshold value (step S131a), the one or more processors 120 determines that there is a high possibility of causing anxiety to the drivers (step S132). On the other hand, when the absolute value of the difference between the other vehicle speed and the passing speed is less than the second threshold value and the passage expected time is larger than the first threshold value (step S131b; No, and step S131a; No), it is determined that there is no high possibility of giving anxiety to the drivers (step S133).

The one or more processors 120 are typically configured to perform one of the determination processes as shown in the examples described above. However, it may be configured to execute by selecting one from a plurality of determination process according to the condition.

FIG. 4 is referred again. After the determination process is executed, the driving state determination process (step S140 to step S180) is executed. First, by executing the determination process, when it is determined that there is a high possibility of causing anxiety to the drivers (step S140; YES), the processing proceeds to step S150. When it is determined that the possibility of causing anxiety to the driver is not high (step S140; No), the process proceeds to step S170.

In step S150, the one or more processors 120 execute a process for notifying drivers that a switch to manual driving is to be performed. The notification is performed via the HMI device 400. That is, the one or more processors 120 generate and output control signals for the HMI device 400 by executing the processing. Then, the HMI device 400 operates according to the control signal, notification by the display of the display device and the sound of the speaker is performed.

In particular, in step S150, the one or more processors 120 may be configured to perform a process to display a reason for the switch to manual driving on the display device. Here, the display of the reason for switching to the manual driving is a display that the driver can recognize that the autonomous driving passes through the lane-free merging point that can not be continued. For example, it is a display such as “a high difficulty merging point in the future” or the like. By thus displaying the reason for switching to the manual driving, the driver can recognize in advance that the driving operation for passing the lane-free merging point is required, it is possible to prepare for manual driving.

After step S150, the process proceeds to step S160.

In step S160, the one or more processors 120 perform a switch to manual driving upon passing through the lane-free merging point. Switching to manual driving is performed, for example, by generating a control signal to notify that the system is turned off to the travel control device 600. Here, the one or a plurality of processors 120 executes a process of accepting a response of the driver in response to the notification made in the step S150, and switches to the manual driving when the response of the driver is accepted. Acceptance of the response of the driver is performed, for example, by the operation of the driving operation device 500 (steering wheel operation, depression of the gas pedal, etc.) is performed. Alternatively, the operation is performed when the HMI device 400 is operated (e.g., by pressing a switch or responding to sound).

Further, the one or more processors 120 may be configured to perform a process of switching to a manual driving without accepting a driver response when a response is not accepted for a predetermined time from the time of notification. With this configuration, the troublesomeness of the driver responding to the notification can be reduced.

After S160 of steps, the process ends this time.

In step S170, one or more processors 120 make a hands-on request.

After step S170, the process proceeds to step S180.

In step S180, one or more processors 120 perform hands-on control. That is, the driver continues the autonomous driving in the hands-on state, the switching to the manual driving is performed in certain cases such as autonomous driving can not be continued.

After S180 of steps, the process ends this time.

In this manner, the one or more processors 120 execute processing relating to determination of continuation of the autonomous driving and switching to the manual driving. Also by the autonomous driving system 10 according to this embodiment, the driving condition determination method for determining the switching to the continuation and manual driving of the autonomous driving of the vehicle 1 in accordance with the running environment is realized.

### 4. Effect

As described above, according to the present embodiment, the determination process is executed when the lane-free merging point on the traveling route 2 is detected. Then, when it is determined that there is a high possibility of causing anxiety to the driver, the autonomous driving is continued, and when it is determined that there is a high possibility of causing anxiety to the driver, the switching to the manual driving is performed. This makes it possible to determine the continuation of the autonomous driving and the switching to the manual driving without decreasing the availability of the autonomous driving when passing through the lane-free merging point.

What is claimed is:

1. A driving condition determination method that determines a continuation of autonomous driving of a vehicle and switching to manual driving in accordance with a traveling environment, the driving condition determination method comprising:
detecting a lane-free merging point on a traveling route of the vehicle by the autonomous driving;
executing a determination process that determines whether there is a high possibility of causing a driver to feel anxious when the vehicle passes through the lane-free merging point by the autonomous driving based on a passing speed when the vehicle passes through a merging portion or a length of a merging section, in response to a detection of the lane-free merging point; and
continuing the autonomous driving when the driving condition determination method does not determine that there is a high possibility of causing the driver to feel anxious, and performing switching to the manual driving when the driving condition determination method determines that there is a high possibility of causing the driver to feel anxious.

2. The driving condition determination method according to claim 1, wherein the determination process includes determining that a possibility of causing the driver to feel anxious is high when an expected passage time acquired by dividing the length of the merging section by the passing speed is equal to or less than a predetermined first threshold value.

3. The driving condition determination method according to claim 2, wherein the determination process includes changing the first threshold value in accordance with an absolute value of a difference between the passing speed and an expected speed when another vehicle traveling in another lane at the lane-free merging point passes through the merging portion.

4. The driving condition determination method according to claim 1, wherein the determination process includes determining that a possibility of causing the driver to feel anxious is high when an absolute value of a difference between the passing speed and an expected speed when another vehicle traveling in another lane at the lane-free merging point passes through the merging portion is equal to or more than a predetermined second threshold value.

5. The driving condition determination method according to claim 3, further comprising calculating a target speed of the vehicle when the vehicle passes through the merging portion as the expected speed when assuming that the vehicle travels in the other lane based on map information.

6. The driving condition determination method according to claim 1, further comprising: calculating a merging start point at which the vehicle passes through a hard nose or a soft nose of the lane-free merging point and calculating a merging end point at which a lane width becomes equal to or less than a predetermined value after the vehicle passes through the merging start point based on map information; and calculating a length between the merging start point and the merging end point as the length of the merging section.

7. The driving condition determination method according to claim 1, wherein performing switching to the manual driving includes displaying a reason for switching to the manual driving on a display device.

8. The driving condition determination method according to claim 1, wherein performing switching to the manual driving includes:
sending a notification to the driver that switching to the manual driving is to be performed;
receiving a response of the driver to the notification; and
switching to the manual driving when reception of the response is not performed for a predetermined time from a time point of the notification.

9. An autonomous driving system that performs autonomous driving of a vehicle, the autonomous driving system comprising one or more processors, wherein the one or more processors executes:
a process of detecting a lane-free merging point on a traveling route of the vehicle by the autonomous driving;
a determination process that determines whether there is a high possibility of causing a driver to be anxious when the vehicle passes through the lane-free merging point by the autonomous driving based on a passing speed when the vehicle passes through a merging portion or a length of a merging section, in response to a detection of the lane-free merging point; and
a driving state determination process that continues the autonomous driving when the one or more processors does not determine that there is a high possibility of causing the driver to feel anxious, and that performs switching to manual driving when the one or more processors determines that there is a high possibility of causing the driver to feel anxious.

10. The autonomous driving system according to claim 9, wherein the determination process includes determining that a possibility of causing the driver to feel anxious is high when an expected passage time acquired by dividing the length of the merging section by the passing speed is equal to or less than a predetermined first threshold value.

11. The autonomous driving system according to claim 10, wherein the determination process includes changing the first threshold value in accordance with an absolute value of a difference between the passing speed and an expected speed when another vehicle traveling in another lane at the lane-free merging point passes through the merging portion.

12. The autonomous driving system according to claim 9, wherein the determination process includes determining that a possibility of causing the driver to feel anxious is high when an absolute value of a difference between the passing speed and an expected speed when another vehicle traveling in another lane at the lane-free merging point passes through the merging portion is equal to or more than a predetermined second threshold value.

13. The autonomous driving system according to claim 11, wherein the one or more processors is configured to further execute a process of calculating, as the expected speed, a target speed of the vehicle when the vehicle passes through the merging portion when the vehicle is assumed to travel the other lane based on map information.

14. The autonomous driving system according to claim 9, wherein the one or more processors further executes a process of calculating a merging start point at which the vehicle passes through a hard nose or a soft nose of the lane-free merging point and calculating a merging end point at which a lane width becomes equal to or less than a predetermined value after the vehicle passes through the merging start point, and a process of calculating a length between the merging start point and the merging end point as the length of the merging section.

15. The autonomous driving system according to claim 9, further comprising a display device, wherein the driving state determination process includes displaying on the display device, a reason for switching to the manual driving when performing switching to the manual driving.

16. The autonomous driving system according to claim 9, wherein when the driving state determination process determines that a possibility of causing the driver to feel anxious is high, the driving state determination process includes:
a process of sending a notification that switching to the manual driving is to be performed;
a process of receiving a response of the driver to the notification; and
a process of switching to the manual driving when reception of the response is not performed for a predetermined time from a time point of the notification.
